(19) United States
(12) Patent Application Publication
(10) Pub. No.: US 2008/0061487 A1
(43) Pub. Date: Mar. 13, 2008

(54) CLAMP

(75) Inventor: John Eldon FALK, Simi Valley, CA (US)

Correspondence Address: LADAS & PARRY, 5670 WILSHIRE BOULEVARD, SUITE 2100, LOS ANGELES, CA, 90036-5679, US

(73) Assignee: ARC MACHINES, INC., Pacoima, CA (US)

(21) Appl. No.: 11/837,466

(22) Filed: Aug. 10, 2007

Related U.S. Application Data
(60) Provisional application No. 60/843,457, filed on Sep. 8, 2006.

(51) Int. Cl. B23Q 3/00

(52) U.S. Cl. 269/52; 219/59.1; 228/212; 269/287

(57) ABSTRACT

A clamp for a cylindrical workpiece useful for a tube welder includes two clamping plates arranged to move in the same plane to engage the workpiece in a central opening formed by cooperating indentations in the clamping plates and both clamping plates are provided with at least one supported beam flexible member for pressing against the workpiece and accommodating variations in the diameter of the workpiece from the nominal diameter.

### CROSS REFERENCE TO RELATED APPLICATION

This application claims the benefit of U.S. provisional patent application Ser. No. 60/843,457, filed on Sep. 8, 2006 for a “Clamp,” by John Falk, and assigned to Arc Machines, Inc., the disclosure of which is incorporated herein by reference.

### STATEMENT REGARDING FEDERALLY SPONSORED RESEARCH OR DEVELOPMENT

None.

### FIELD

The present disclosure relates to the art of work holders and, more particularly, to clamps for holding objects such as cylindrical or quadrant symmetrical workpieces and particularly tubes.

### BACKGROUND

Orbital head welding devices or tube welders are well known. Tube-to-tube welding (hereinafter, “tube welding”) requires that two tubing sections be held so that two pieces of tubing is in abutting coaxially aligned relationship during the orbiting of the welding head about the tube ends. Tube welding devices therefore usually contain clamps for holding the pieces of tubing in position for being welded to each other. Arc Machines. Inc., the assignee of this application and the invention described in the application, makes a well-known line of tube welders such as the Model 8 or 9 series.

Clamps must open to receive the workpiece and then clamp onto the workpiece. One type of clamps uses jaws or plates that advance toward each other to surround the workpiece.

U.S. Pat. No. 4,810,848 to Kazlauskas (the “'848 patent”), the disclosure of which is incorporated by reference for all purposes allowed by law and regulation, discloses a tube welder having a pair of identical arc-shaped first clamping plates 142 and 144. The first clamping plate 142 is mounted on a main housing 16 and the first clamping plate 144 is mounted on a clamp housing 156 (or 146) pivotally mounted by a pivot pin 148 to the main housing 16. The clamp housing 156 has one position in which the first clamping plates 142 and 144 are in contact and define a through opening 152. Access is provided to the through opening 152 by rotating the clamp housing 156 about the pivot pin 148 in order to separate the clamping plates 142 and 144 in order to insert a tube section into the through opening 152. A pair of identical arc-shaped second clamping plates 154 and 156 are provided and mounted so that they are parallel to the first clamping plates 142 and 144. The first clamping plates 142 and 144 are identical to the second clamping plates 154 and 156.

The first clamping plates 142 and 144 each have a centrally located, half circle indentation which cooperate together to form part of the through opening 152. Each of the second clamping plates 154 and 156 also have a centrally located, half circular indentation which cooperate together to form part of the through opening 152. The first clamping plates 142 and 144 can fasten to one tube section 12 and the second clamping plates 154 and 156 can fasten to another tube section 14 in order to hold an end of the tube section 12 in coaxial proximity to an end of the tube section 14 for circumferential welding of the tube sections 12 and 14 to each other. The tube sections 12 and 14 are of the same diameter.

The clamping plates used in tube welders and other devices must accommodate a range of sizes due to size variances of the diameters of the tube sections used. In addition, they must firmly hold the tube sections in place for welding and to minimize workpiece deformations as much as possible.

Various designs for clamping plates have been employed for this purpose. U.S. Pat. No. 4,810,848 discloses that the plates 142, 144, 154 and 156 are constructed to provide for a limited amount of expansion so as to permit snug attachment of the tube welder 10 onto tubes 12 and 14 having size variances in the diameter of the tubes. Concentric and slightly spaced slots 158 and 160 permit radial deflection as shown in FIGS. 7A and 7B of the '848 patent, which show one quadrant of a clamping plate. As outward pressure is applied against plate 144, there is a tendency for section 162 to deflect from the solid line position shown in FIG. 7a to the solid line position shown in FIG. 7b. As a result, there is intended to be substantially even movement of the quadrant with respect to the tube 12 so that no one portion of the quadrant moves any distance greater than another portion of the quadrant. This allegedly even moving is accomplished through the use of the two slots 158 and 160.

The radial deflection taught in U.S. Pat. No. 4,810,848 is due to the elastic deformation of cantilever beams (the sections 162 and 164) with respect to the anchors of the beams in the regions indicated by points “A” and “B” in FIGS. 7A and 7B of the '848 patent. While clamping plates of this design may be made to accommodate a good range of variance in tube diameter, the firmness of the clamping is poor as long as the beams are cantilevers. Once the beams are sufficiently deformed to dose the slots 158 and 160, the pressure exerted on the tube will no longer be elastic and the possibility of damage to the tube will exist if further clamping pressure is applied.

Other clamping plates are known that have slots for creating cantilever beams to provide for elastic deformation of the clamping plate during clamping, as in U.S. Pat. No. 4,810,848. Thus, German Offenlegungsschrift (“disclosure document”) patent publication DE 10006712 A1 discloses two embodiments of clamping plates that contain concentric slots that create cantilever beams whereby tubes of diameter larger than that of the opening initially defined by the clamping plates may be held due to radial deflection of at least a portion of the clamping plates.

U.S. Pat. No. 4,973,823 to Benway et al. for a “Collet Assembly for Cylindrical Workpieces” discloses collets for clamping devices for cylindrical workpieces that have individual surface portions in the form of clamp faces formed by a concentric slot 74 and a radial slot 72. These individual surface portions have the form of cantilever beams. The individual surface portions are thus mounted for independent flexing movement to accommodate workpiece tolerance variations.

The clamping plates or collets of the references discussed above all rely only on cantilever action to provide pressure against the workpiece. Clamping plates and collets using cantilever action will have a large degree of clamping force variation even within the normal production tolerances of a given pipe/tube diameter. Additionally, once the moveable element has rotated radially a certain distance it will contact the other wall of the related slot and stop providing elastic pressure to the workpiece; simply providing for a larger slot means for greater displacements can either over stress the material causing strain, or not perform well (if at all) at one end of the workpiece diameter variation(s) as a result of the high ratio. The result is ineffective clamping unless greater compression is provided. Greater compression may damage either the cylindrical workpiece or the clamping plate because the compression is materially limited. Thus the range of sizes that may be accommodated while providing adequate clamping pressure is also limited.

The clamping plates used in a tube welder or other device preferably should have the following characteristics:

1. firm attachment to the workpiece at all accommodated workpiece diameters so that rotation and/or twisting both radially or axially of the workpiece is minimized;

2. minimization of deformation of the workpiece as a result of elastic clamping pressure;

3. accommodation of workpieces having different diameters due to normal production variance;

4. accommodation of workpieces having different cross-sectional shapes;

5. durability; and

6. lower cost to manufacture.

Improved clamps are needed that possess these desirable characteristics.

### SUMMARY

The devices disclosed below achieve these goals by using a supported beam technology. The clamps disclosed herein are useful as a tube clamp unit in an orbiting head tube welder and will be described with particular reference thereto; however, the invention is capable of broader application and could be incorporated in a wide variety of work holders and clamping units for different types of workpieces, including non-cylindrical workpieces. The clamps disclosed herein readily accommodate workpieces with different diameters due to normal size variance while providing firm attachment to the workpiece at all accommodated workpiece diameters so that the workpiece does not rotate or twist.

In an aspect of the clamps disclosed herein, a clamping device for holding workpieces is provided, comprising a pair of clamp halves adapted to be moved toward and away from each other, each of the clamp halves carrying a clamping plate adapted to engage on opposite sides of the workpiece when the clamp halves are moved toward each other, each of the clamping plates having an inner clamping surface adapted to receive a part of the workpiece when the clamp halves are moved toward each other, and each inner clamping plate surface comprising at least one inner clamping surface portion, wherein the inner clamping surface portion is mounted for flexing movement as a supported beam

In another aspect of the clamps disclosed herein, a clamp for a workpiece is provided, comprising a pair of opposed clamping plates each having an inner circumferential surface defining an opening whereby the clamping plates when joined together define a central through opening for receiving the workpiece, at least one circumferential slot defined in at least one clamping plate for forming at least one flexible member at the inner circumferential surface, the flexible member having a free end radially inward of a support wherein the flexible member acts as a supported beam when the clamping plates are clamped against the workpiece.

In yet another aspect of the clamps disclosed herein, a device for clamping onto a workpiece is provided comprising a first clamp half and a second clamp half, the first clamp half further comprising a first clamping plate, the second clamp half further comprising a second clamping plate, each of the first and second clamping plates having an indentation, the indentations of the first and second clamping plates cooperating to form a center opening for receiving a workpiece when the first clamp half is moved adjacent the second clamp half, each of the first and second clamping plates comprising a concentric flexible member adjacent the indentation, the flexible member having a free end and the clamping plate defining a concentric slot adjacent to and radially outward from the flexible member, each of the first and second clamping plates further comprising a radially outward support for the free end wherein the flexible member is adapted to act as a supported beam when a workpiece is clamped into the indentation and the center opening may be enlarged to permit snug mounting of the first and second clamping plates onto workpieces having a size variance.

Still another aspect of the clamps disclosed herein provides a clamp for a workpiece comprising a housing with two clamp halves moveable toward and away from each other, the clamp halves having opposed faces that are brought together when the clamp halves are moved toward each other, the opposed faces of each clamp half defining an indentation for receiving a clamping plate, wherein the clamping plate is shaped to fit into the indentation and has a face that defines an indentation with a circumferential surface, the faces of the clamping plates when brought to be adjacent to each other together defining a circumferential opening for receiving the workpiece, and each clamping plate comprises two quadrant symmetric supported beams in the circumferential surface of the indentation of the clamping plate.

### BRIEF DESCRIPTION OF DRAWINGS

The present disclosure will be understood and appreciated more fully from the following detailed description taken in conjunction with the drawings. The drawings are described below.

FIG. 1 is a perspective view from above of a preferred embodiment of the clamp according to the invention shown in an open position and about to receive a workpiece (a piece of tubing).

FIG. 2 is a front side view of the clamp and workpiece of FIG. 1.

FIG. 3 is a perspective view from above of the clamp and workpiece of FIG. 1 in which the clamp is shown in the closed position.

FIG. 4 is a front side view of the clamp and workpiece of FIG. 4.

FIG. 5 is a right side view of the clamp and workpiece of FIG. 4.

FIG. 6 is a front side view of one of the clamping plates shown as part of the clamp of FIGS. 1-5, and a workpiece shown in cross-section.

FIG. 7 is a detail view of a portion of the clamping plate and workpiece of FIG. 6.

FIG. 8 is a perspective view of the clamping plate and workpiece of FIG. 6.

FIG. 9 is a front side view of the clamping plate and workpiece of FIG. 6 in which the workpiece is in contact with the clamping plate.

FIG. 10 is a front side view of the clamping plate of FIG. 6 showing (flexible member 14 in solid line) its configuration in which a workpiece having a larger diameter than the nominal diameter (over variation) is forced against the clamping plate when the clamp is dosed and the situation (flexible member 14 in dashed line) in which a workpiece having a smaller diameter than the nominal diameter (under variation) is forced against the clamping plate when the clamp is dosed.

FIG. 11 is a front side view of a second embodiment of a clamping plate according to the invention engaging or clamping a workpiece (a piece of tubing).

### DETAILED DESCRIPTION OF PREFERRED EMBODIMENTS

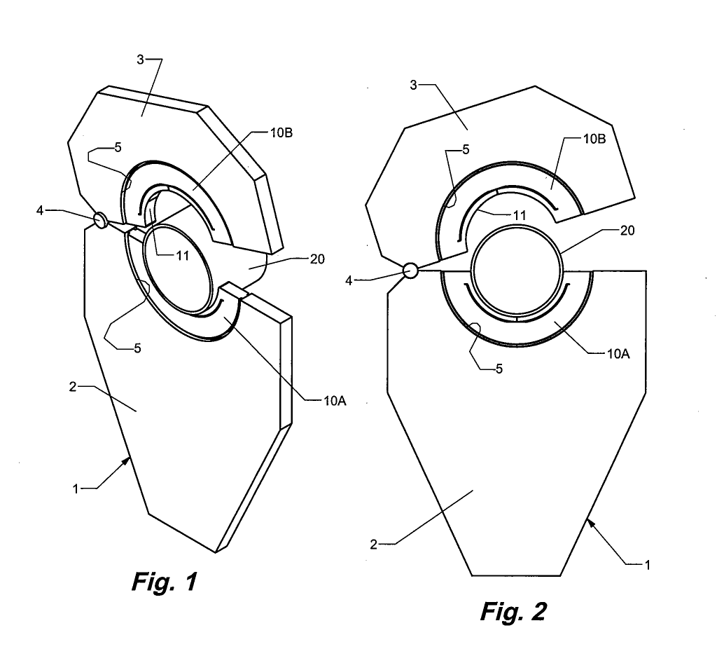

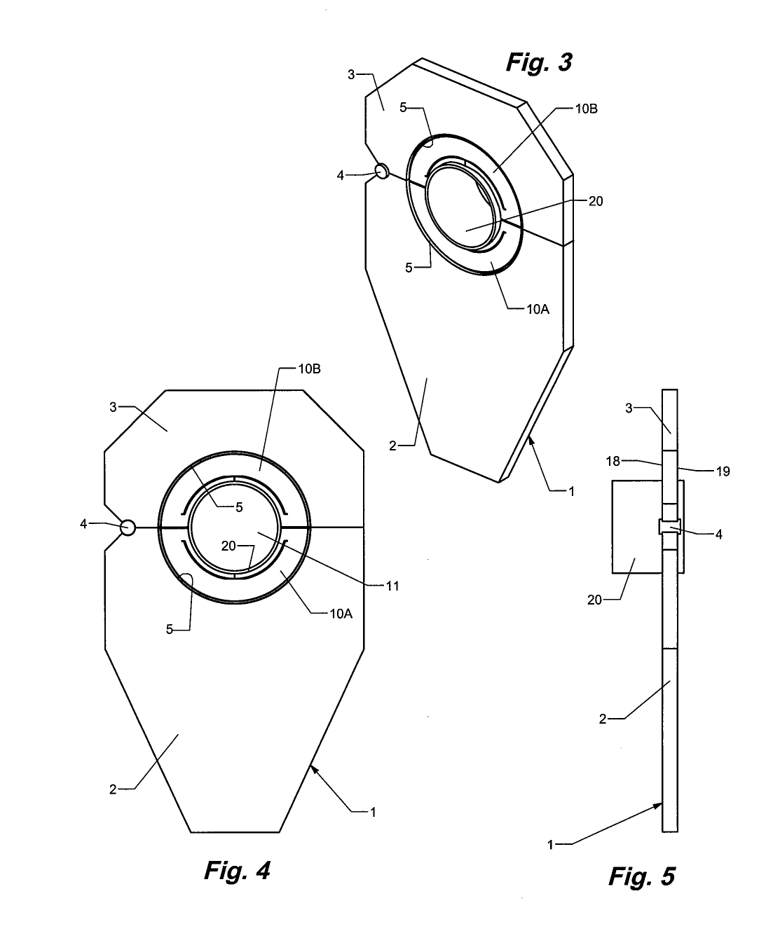

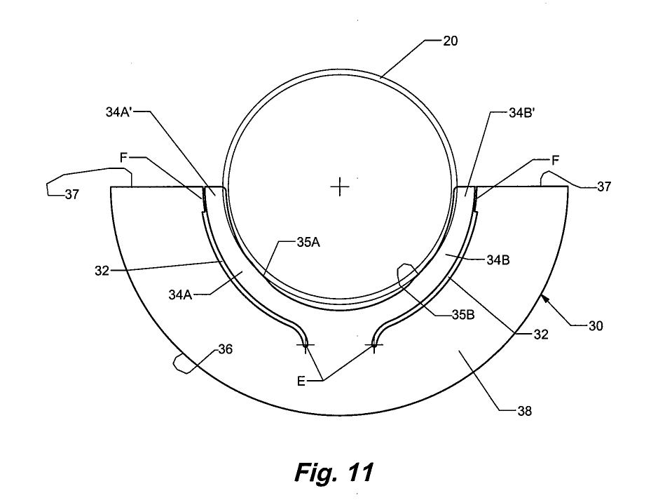

A preferred embodiment of a clamp 1 according to the invention is shown in FIGS. 1-5. FIGS. 6-10 show a preferred embodiment of a clamping plate 10A for use in the clamp 1. FIG. 11 shows a second preferred embodiment 30 of a clamping plate.

Referring to FIGS. 1-5, a preferred embodiment of a clamp 1 is shown. The clamp 1 is suitable for use with an orbital welding device or tube welder although, as noted above, its application is to be understood to be not so limited. The clamp 1 may hold any elongated workpiece, as long as the workpiece is quadrant-symmetric about a major axis of at least a portion of the workpiece. The clamp 1 therefore may hold, for example, a tube, cylinder bar stock, or bar stock having a rectangular, hexagonal or any cross-section having a regular cross-section.

The clamp 1 has a first clamp half 2 hingably connected by pivot 4 to a second clamp half 3. The clamp halves 2 and 3 have surfaces provided with indentations for holding the clamping plates 10A and 10B, respectively. Rotation of the clamp half 3 towards the clamp half 2 will bring the clamping plates 10B and 10A together to hold a cylindrical workpiece in a central opening access 11. The clamping plates 10A and 10B of this embodiment are identical to each other and thus could be interchanged.

A workpiece in the form of a piece of tubing 20 is shown in FIGS. 1-5. In FIGS. 1 and 2 the second clamp half 3 has been rotated about the pivot 4 away from the first clamp half 2, which will permit the piece of tubing 20 to be inserted into the central opening access 11.

It will be understood by those of skill in the art that the means provided for supporting the clamp 1 are a matter of choice. A number of means of support are possible and may be used with clamps made according to the disclosure. Thus, two of the clamps 1 may be used in an orbital welding machine in the manner shown and described in U.S. Pat. Nos. 4,810,848 and 5,223,686, 5,563,391, and 6,380,505, the disclosures of which in connection to the use of clamps in an orbital welding machine is incorporated by reference as if set forth in full herein.

FIGS. 3-5 show the clamp 1 fully engaged to the piece of tubing 20. The second clamp half 3 has been rotated in those drawings so that it is adjacent to the first clamp half 2. It will be understood by those of skill in the art that some level of torque will be exerted on the second clamp half 3 in order to press its associated clamping plate 10B against the clamping plate 10A of the first clamp half 2. The clamp 1 may be locked or kept in this position by a locking unit not shown in the drawings. Locking units may be of any form suitable for a clamp, as is known to those skilled in the art, such as those disclosed in U.S. Pat. Nos. 4,810,848, 5,196,664, and 5,223,686, the disclosure of which in connection to locking units for clamps is incorporated by reference as if fully set forth herein.

The first clamp half 2 and the second clamp half 3 each have a substantally semi circular or semicylindrical indentation 5 arranged so that the indentations 5 of the clamp halves 2 and 3 form a substantially circular or cylindrical opening when the clamp 1 is closed as shown in FIGS. 3-5. Each of the indentations 5 is adapted to receive a arc-shaped clamping plate 10A or 10B. The clamping plate 10A that is placed in the indentation 5 of the first clamp half 2 and the clamping plate 10B that is placed the indentation 5 of the second clamp half 3 are preferably identical, as noted above. When the clamp 1 is in the closed position, as shown in FIGS. 3-5, the clamping plates 10A and 10B will engage the piece of tubing 20 in indentations in the clamping plates 10A and 10B that define a substantially circular or cylindrical central opening access 11.

It will be understood that the shapes of the clamp halves 2 and 3, the indentations 5, and the clamping plates 10A and 10B shown in the drawings are currently preferred but also are matters of choice and may be varied. The shape of the indentations in the clamping plates 10A and 10B, and thus the central opening access 11, preferably are not exactly circular or cylindrical, as further described below, although they may be so shaped.

The clamping plates 10A and 10B may be inserted and removed from the indentations 5 as needed. Those of skill in the art will appreciate that different pairs of clamping plates 10A and 10B may be used to engage workpieces of different diameters as the situation requires. Thus, instead of changing the clamp 1, one need only change the clamping plates 10A and 10B in order to accommodate workpieces of a different diameter.

FIGS. 6-10 each depict the clamping plate 10A shown in FIGS. 1-5 as part of the clamp 1. It will be understood that in this embodiment clamping plate 10B is identical to clamping plate 10A and the discussion of clamping plate 10A will also apply to clamping plate 10B. FIG. 6 shows the clamping plate 10A about to receive the piece of tubing 20. The clamping plate 10A, as noted before, preferably is arc shaped and is quadrant-symmetric, meaning that it has two quadrants that are symmetrical to each other about a radial centerline. In this specification, “circumferential” refers to a surface or curved line segment in the clamping plate, all points of which are generally equidistant from the surface of a cylindrical workpiece when the clamping plate is placed around the workpiece. “Radial” when used with respect to a direction or line segment refers to a straight line in the clamping plate that extends perpendicularly from the major axis of the workpiece. When referring to a surface or plane, “radial” refers to a surface or plane that contains the major axis of a cylindrical workpiece when the clamping plate is placed around the workpiece and “transverse radially” refers to a surface or plane that is perpendicular to the major axis of a cylindrical workpiece when the clamping plate is placed around the workpiece.

The clamping plate 10A has a front side surface 18 as shown in FIG. 6 and a backside surface 19 as indicated in FIG. 5, an inner circumferential surface 15 that contacts the workpiece, and an outer circumferential surface 16 that engages the clamp half 2 or 3 in the indentation 5 of the clamp halves 2 and 3. The front side surface 18 and the back side surface 19 are transverse radial surfaces. The clamping plate 10 also has two parallel surfaces 17 that are substantially radial surfaces.

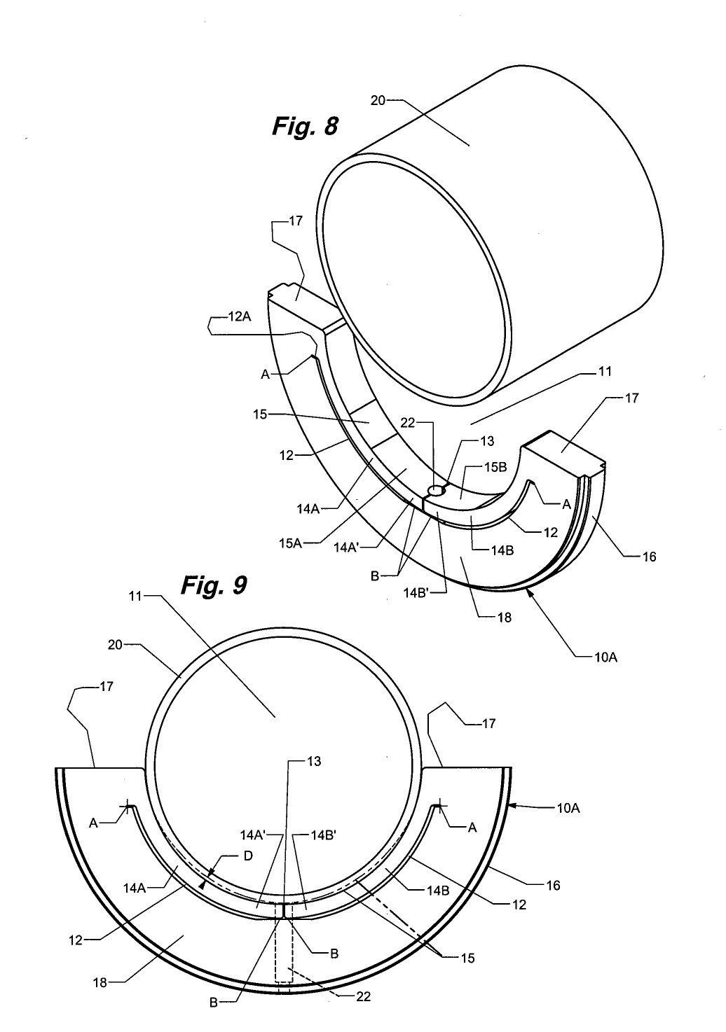

The clamping plate 10A is preferably fabricated from common alloys such as aluminum or titanium alloys. FIGS. 8 and 9 show a centering hole 22 formed along a central radial axis of the clamping plate 10A which may be used to receive a screw in order to secure the clamping plate 10A to the clamp half 2.

The clamping plate 10A has cut or milled into it a circumferential slot 12 that communicates between the front side surface 18 and the back side surface 19. The circumferential slot 12 is symmetrical about the radial centerline of the clamping plate 10A. A radial slot 13 is cut or milled into the clamping plate between the front side surface 18 and the back side surface 19. The radial slot 13 preferably runs along the radial centerline of the clamping plate 10 and communicates between the circumferential slot 12 and the inner circumferential surface 15.

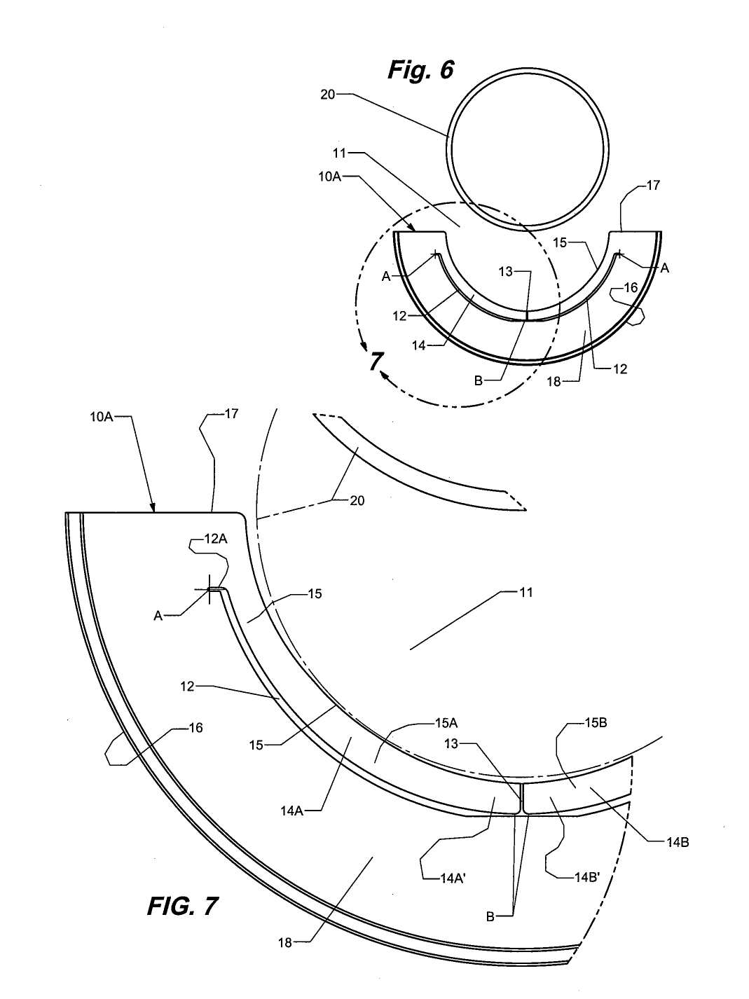

FIG. 7 is a blowup of a portion of FIG. 6, showing only one quadrant of the clamping plate 10A, and depicts in greater detail the circumferential slot 12 and the radial slot 13. The effect of the circumferential slot 12 and the radial slot 13 is to create flexible members 14A and 14B and to divide most of the circumferential surface 15 into portions 15A and 15B that are the inner circumferential surfaces of flexible members 14A and 14B. Each flexible member 14A and 14B pivots about a point A at one end and will come into contact when under load with a support B at its free end 14A′ or 14B′ in a manner described below.

The support B is a portion of the radially outward wall of the slot 12 that has been stepped or raised radially inward (toward the workpiece and the inner circumferential surface 15). Preferably, the distance separating the free end 14A′ or 14B′ of the flexible member 14A or 14B is as small as reasonably priced machining will permit, because the flexible members 14A and 14B will act as a supported beam and not as a cantilever when under load. It will be understood that a supported beam is one that has a support on either end but a cantilever is anchored or supported only at one end. Because the flexible members 14A and 14B are supported beams when under load, to cause deflection of the flexible members 14A and 14B under load will require a greater radially outward force than would be the case if the flexible members 14A and 14B acted as cantilever beams as in earlier devices, such as that shown in U.S. Pat. No. 4,810,848. As a result, the radially inward clamping force exerted on the workpiece will be greater as well, and a more secure clamping action will be obtained over a range of effective workpiece diameters.

The circumferential slots 12 in the vicinity of points A preferably turn radially outward to form subslots 12A to act as stress de-centralizers, as shown in FIG. 7. These subslots 12A help the flexible members 14A and 14B to flex radially outward between the points A and the free ends 14A′ and 14B′. Clamping plates 10A and 10B that have inner circumferential surfaces 15 of small diameter in order to accommodate workpieces of smaller diameter, such as small diameter tubing, preferably will have subslots 12A that are longer with respect to the length of the circumferential slot 12 than is the case for tubing of greater diameter. This is because common machining or fabricating processes result in a finite width of the slots 12 in the region of the supports B when creating the free ends 14A′ and 14B′ of the supported beam. As a result, the flexible elements 14A and 14B for the clamping plates 10A and 10B that are designed to accommodate smaller diameter tubing must be capable of flexing relatively more than the flexible elements 14A and 14B of the clamping plates 10A and 10B that are designed to accommodate larger diameter tubing. Thus, a relatively longer subslot 12A preferably should be provided for the clamping plates 10A and 10B designed to accommodate smaller diameter tubing.

A pair of clamping plates 10A and 10B supported by the clamp halves 2 and 3 may engage workpieces with a normal variation of diameter sizes while securely holding the workpieces without deforming them. The diameter of the inner circumferential surface 15 of the clamping plate 10A is shown in its normal and unstressed position in FIG. 6. In FIG. 6 the clamping plate 10A is not engaged to the piece of tubing 20. The inner circumferential surface 15 is shaped to accommodate a workpiece with the greatest diameter consistent with normal or expected variation of diameters. It will also be noted that the inner circumferential surface 15 preferably does not have a perfectly cylindrical surface although it could have such a surface. The currently preferred shape of the inner circumferential surface 15 is best shown in FIG. 7 and is not perfectly cylindrical. It has a greater diameter near its junctures with the radial surfaces 17 and the slot 13 and a smaller diameter at about the middle of each of the flexible members 14A and 14B, where the flexible members 14A and 14B will displace the greatest distance. Accordingly, the workpiece will initially contact the inner circumferential surface 15 of the clamping plate 10A at two regions corresponding to the approximate centers of each flexible member 14A and 14B. The clamping pressure on the workpiece will be quadrant-symmetric and will accept a range of workpiece diameters or effective widths. Workpieces having quadrant-symmetric cross sections may be easily accommodated by the combination of the clamping plates 10A and 10B.

FIG. 9 shows the piece of tubing 20 engaging the clamping plate 10A as when the second clamp half 3 is torqued against the first clamp half 2. The dashed curve shows the position of the inner circumferential wall 15 before the workpiece is engaged. When the clamping plates 10A and 10B are forced against the piece of tubing 20 by torquing the clamp halves 2 and 3, as shown in FIGS. 3-5, the flexible members 14A and 14B are forced radially outward and hinge about their pivots at points A. Accordingly, the free ends 14′ and 14B′ are driven against the supports B, the flexible members 14A and 14B are now supported beams in that they are supported by the support B at one end and at its other end by the clamping plate 10A at point A. Once they are supported beams the flexible members 14A and 14B will further deform elastically and radially outward and away from the piece of tubing 20. The ends 14A′ and 14B′ of the flexible members 14A and 14B will accordingly diverge from each other in a concentric direction above the support B. The radial slot 13 will thus widen.

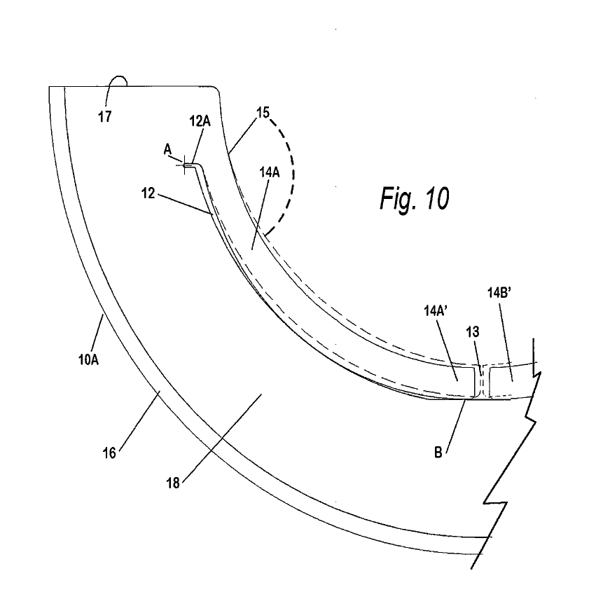

The deflection of the flexible members 14A and 14B when engaging the workpiece or tube section 20 is shown in FIG. 9 indicated by the letter “D.” The deflection of the flexible members 14A and 14B both provides an elastic radially inward pressure on the piece of tubing 20 and also accommodates variations in the diameter of the tube section 20, as is illustrated in FIG. 10.

The flexible members 14A and 14B are deflected radially outward when engaging the tube section 20 and thus narrow the slot 12. The slot 13 is increased in width. The position of the inner circumferential surface 15 prior to clamping the workpiece is shown in phantom for comparison.

FIG. 10 shows, in solid line, a quadrant of the clamping plate 10 in the configuration it has when engaging a workpiece that is larger than the nominal specification. FIG. 10 also shows (flexible members 14A and 14B shown in phantom line) a quadrant of the clamping plate 10A in the configuration it has when engaging a workpiece that is smaller than the nominal specification. The flexible members 14A and 14B are deflected radially outward further for the larger workpiece so that the slot 12 is partially dosed because the flexible members 14A and 14B are contacting a part of the radially outward wall of the slot 12. Accommodating a larger workpiece causes the free end 14A′ of the flexible member 14A to slide circumferentially with respect to the support B as the flexible member 14A is more greatly deflected, and the same is true of flexible member 14B. The slot 13 will be more increased in width compared to its state when a smaller workpiece is accommodated. The slot 13 will be at its narrowest when no workpiece is engaged at all and thus the flexible members 14A and 14B are not stressed.

It has been determined by three dimensional (3D) solid modeling and Finite Elemental Analysis that a satisfactory range of accommodation can be provided for different sizes of cylindrical workpieces or tube sections while providing a very secure and tight clamping action on the workpiece that does not permit twisting or rotation of the workpiece. For example, for a workpiece of tubing having a nominal two inch (50.80 mm) diameter, clamping plates according to the design shown in FIGS. 1-10 can accommodate tubing having a minimum diameter of 1.985 inches (50.42 mm) and a maximum diameter of 2.025 inches (51.43 mm), a range of 0.040 inches (1.02 mm), with satisfactory clamping action. As noted in U.S. Pat. No. 4,810,848, a range of +/−0.010 inches respectively will suffice to accommodate nearly all tubing. For a nominal diameter of two inches (50.80 mm) the common minimum diameter is 1.99 inches (50.54 mm) and 2.023 inches (51.37 mm), a range of 0.033 inches.

Clamping devices made according to the invention have been found to exhibit a range of clamping force across their ranges of accommodation that is smaller and thus superior to known clamps. At small diameters the ratio of maximum clamp force to minimum clamp force may be as low as 3.5 to 1 when measured across the range of accommodation whereas the ratio may be as low as 2.6 to 1 for larger diameter. The comparable ratios for known clamps are much higher. For a clamp built according to the dual cantilever design shown in U.S. Pat. No. 4,810,848, the ratios will be 18 to 1 for smaller diameter tubes and 10 to 1 for larger diameter tubes.

FIG. 11 shows a second preferred embodiment of a clamping plate 30. The clamping plate 30 has a front side surface 38, an outer circumferential surface 36, an inner circumferential surface 35 and radial surfaces 37 that are essentially the same as the corresponding surfaces of the clamping plate 10A described above. However, in the second embodiment 30 two circumferential slots 32 are provided, one for each quadrant of the clamping plate 30. The slots are created between the pivot points E and the radial surfaces 37. As a result, the inner circumferential surface 35 of the clamping plate 30 is mostly divided into two inner circumferential surfaces 35A and 35B.

The slots 32 divide the flexible elements 34A and 34B from the rest of the clamping plate 30. The flexible elements 34A and 34B may rotate about their respective pivot points E radially outward when a workpiece is engaged. The flexible elements 34A and 34B will contact the supports F at their free ends 34A′ and 34B′. The supports F in the clamping plate 30 are a section of the clamping plate 30 at the end of the slot 32 closest to the radial surface 37 that has been formed so as to narrow the slots 32 sufficiently as to provide a minimal amount of travel between the end 34A′ and 34B′ and the supports F.

As in the clamping plates 10A and 10B, the flexible members 34A and 34B will deform elastically and radially outwardly from the workpiece (here, a piece of tubing 20) when the workpiece 20 is clamped between two clamping plates 30 in a clamp such as the clamp 1 shown in FIGS. 1-5. The free ends 34A′ and 34B′ will also contract circumferentially from the radial surfaces 37.

While illustrative embodiments of the clamps disclosed herein have been shown and described in the above description, numerous variations and alternative embodiments will occur to those skilled in the art and it should be understood that, within the scope of the appended claims, the invention may be practised otherwise than as specifically described. Such variations and alternative embodiments are contemplated, and can be made, without departing from the scope of the invention as defined in the appended claims.

What is claimed is:

1. A clamping device for holding workpieces, comprising a pair of clamp halves adapted to be moved toward and away from each other, each of the clamp halves carrying a clamping plate adapted to engage on opposite sides of the workpiece when the clamp halves are moved toward each other, each of the clamping plates having an inner clamping surface adapted to receive a part of the workpiece when the clamp halves are moved toward each other, and each inner clamping plate surface comprising at least one inner clamping surface portion, wherein the inner clamping surface portion is mounted for flexing movement as a supported beam.

2. The clamp according to claim 1 wherein the inner clamping surfaces are quadrant symmetrical.

3. The clamp according to claim 2 wherein each inner clamping surface comprises an inner clamping surface portion in each quadrant.

4. A clamp for a workpiece, comprising a pair of opposed clamping plates each having an inner circumferential surface defining an opening whereby the clamping plates when joined together define a central through opening for receiving the workpiece, at least one drcumferential slot defined in at least one clamping plate for forming at least one flexible member at the inner circumferential surface, the flexible member having a free end radially inward of a support wherein the flexible member acts as a supported beam when the clamping plates are clamped against the workpiece.

5. The clamp according to claim 4 wherein the clamping plates are quadrant symmetrical.

6. The clamp according to claim 5 wherein each clamping plate comprises a flexible member in each quadrant.

7. The clamp according to claim 4 wherein the support is formed as part of a boundary of the circumferential slot.

8. The clamp according to claim 4 wherein each clamping plate further defines a radial slot bisecting the inner circumferential surface and the circumferential slot extends circumferentially on either side of the radial slot whereby two flexible members are formed and the free ends of the flexible members form either side of the radial slot and the supports are formed radially outward from the free ends as a part of a boundary of the circumferential slot.

9. The clamp according to claim 4 wherein each clamping plate has a radial surface on either side of the opening and defines a circumferential slot, the circumferential slot ending on a radial surface, wherein the free end is adjacent the radial surface and a support is formed in a part of a boundary of the slot below the free end.

10. The clamp according to claim 9 wherein each clamping plate defines two circumferential slots, each circumferential slot ending on a radial surface, wherein a free end is adjacent each of the radial surfaces and a support is formed in a part of a boundary of the slot below each of the free ends.

11. A device for clamping onto a workpiece, comprising:
a first clamp half and a second clamp half, the first clamp half further comprising a first clamping plate, the second clamp half further comprising a second clamping plate, each of the first and second clamping plates having an indentation, the indentations of the first and second clamping plates cooperating to form a center opening for receiving a workpiece when the first clamp half is moved adjacent the second clamp half,
each of the first and second clamping plates comprising a concentric flexible member adjacent the indentation, the flexible member having a free end and the clamping plate defining a concentric slot adjacent to and radially outward from the flexible member, each of the first and second clamping plates further comprising a radially outward support for the free end wherein the flexible member is adapted to act as a supported beam when a workpiece is clamped into the indentation and the center opening may be enlarged to permit snug mounting of the first and second clamping plates onto workpieces having a size variance.

12. A clamp for a workpiece comprising a housing with two clamp halves moveable toward and away from each other, the clamp halves having opposed faces that are brought together when the clamp halves are moved toward each other, the opposed faces of each clamp half defining an indentation for receiving a clamping plate, wherein the clamping plate is shaped to fit into the indentation and has a face that defines an indentation with a circumferential surface, the faces of the clamping plates when brought to be adjacent to each other together defining a circumferential opening for receiving the workpiece, and each clamping plate comprises two quadrant symmetric supported beams in the circumferential surface of the indentation of the clamping plate.
